(19) United States
(12) Patent Application Publication
(10) Pub. No.: US 2014/0225364 A1
(43) Pub. Date: Aug. 14, 2014

(54) Quick-Mounting Pipe Structure

(71) Applicant: TEKTRO TECHNOLOGY CORPORATION, CHANGHUA (TW)

(72) Inventor: SZU-FANG TSAI, CHANGHUA (TW)

(73) Assignee: TEKTRO TECHNOLOGY CORPORATION, CHANGHUA (TW)

(21) Appl. No.: 13/864,280

(22) Filed: Apr. 17, 2013

(30) Foreign Application Priority Data
Feb. 8, 2013 (TW) 102202970

(51) Int. Cl. B60T 17/04; F16L 33/24

(52) U.S. Cl. CPC B60T 17/043; F16L 33/24
USPC 285/247

(57) ABSTRACT

A quick-mounting pipe structure comprises a first tubular fitting, a coupling sleeve, and a hose assembly. The first tubular fitting includes a locking ball. The coupling sleeve is formed with an inner annular protrusion and internal threads at an inner surface thereof. The hose assembly includes a hose and a second tubular fitting. The second tubular fitting is formed with an annular raised portion, an annular recessed portion, and external threads on its outer surface. The second tubular fitting can be inserted into the first tubular fitting to allow the locking ball to be retained in the annular recessed portion of the second tubular fitting. Additionally, the coupling sleeve can be threadedly engaged with the second tubular fitting, thereby providing additional attachment between the first tubular fitting and the second tubular fitting to prevent the second tubular fitting from being pulled out of the first tubular fitting under excessive force.

### (a) TECHNICAL FIELD OF THE INVENTION

The present invention relates to a quick-mounting pipe structure that can provide additional attachment between the fitting components to prevent the hose thereof from being pulled out of the associated hydraulic device when it is subjected to excessive force.

### (b) DESCRIPTION OF THE PRIOR ART

In the recent development of a bicycle's brake system, the brake cable (being hydraulic type or mechanical type) has been gradually changed from the style of routing cable outside the frame to the style of routing cable inside the frame for aesthetic reasons or cable protection. Besides, there is a hydraulic brake hose being developed for quickly mounting to the hydraulic brake lever or hydraulic brake disc of a bicycle. Since the hydraulic brake hose is connected to the brake device through a locking ball and without other mechanism to provide additional fixing, the hose is prone to be pulled out of the hydraulic device when it is subjected to excessive force. Consequently, the hydraulic brake fluid will leak from the brake system and thus risks may occur.

To mitigate the disadvantage of the hydraulic brake hose, the applicant has contrived a quick-mounting pipe structure that can be quickly connected to the hydraulic brake lever or hydraulic brake disc of a bicycle more securely.

### SUMMARY OF THE INVENTION

The primary object of the present invention is to provide a quick-mounting pipe structure that can provide additional attachment between the fitting components to prevent the hose thereof from being pulled out of the associated hydraulic device when it is subjected to excessive force.

To achieve the above object, the quick-mounting pipe structure may comprise a first tubular fitting, a coupling sleeve, and a hose assembly. The first tubular fitting has one end that can be fitted into a hydraulic device and an opposite end that is provided with a locking ball that can be moved inwardly to reach a central passage thereof. The first tubular fitting is formed with an outer shoulder at an outer surface of the opposite end and fitted with a coil spring. The coupling sleeve is movably fitted around the first tubular fitting and the coil spring. The coupling sleeve is formed with an inner annular protrusion and internal threads at an inner surface thereof. The internal threads are located at one end of the coupling sleeve that is away from the first tubular fitting. The inner annular protrusion corresponds to the outer shoulder such that one end of the coil spring is engaged with the outer shoulder of the first tubular fitting and the other end of the coil spring is engaged with the inner annular protrusion of the coupling sleeve. The hose assembly includes a hose and a second tubular fitting provided at one end of the hose. The second tubular fitting can be inserted into the first tubular fitting and the coupling sleeve for allowing the hose assembly to be connected to the hydraulic device. The second tubular fitting is formed with an annular raised portion, an annular recessed portion next to the annular raised portion, and external threads on its outer surface. The external threads of the second tubular fitting can be threadedly engaged with the internal threads of the coupling sleeve. The annular recessed portion can retain the locking ball of the first tubular fitting to allow the second tubular fitting to be locked with the first tubular fitting after the second tubular fitting has been threadedly engaged with the coupling sleeve by the external threads and the internal threads, thereby securely connecting the hose assembly to the hydraulic device. The annular raised portion can push the locking ball to move outwardly to be clear of the annular recessed portion of the second tubular fitting when disengaging the internal threads from the external threads, such that the second tubular fitting can be taken off the first tubular fitting and thus the hose assembly can be removed from the hydraulic device.

According to one aspect of the present invention, the coupling sleeve can be provided with an observation window between the inner annular protrusion and the internal threads thereof.

According to another aspect of the present invention, the coil spring can be a compressible coil spring.

According to a further aspect of the present invention, the second tubular fitting can be fitted with a seal ring around its outer surface in front of the annular raised portion. The seal ring can be an O-ring.

According to a still further aspect of the present invention, the hydraulic device can be a hydraulic brake lever or a hydraulic brake disc.

Other objects, advantages, and novel features of the present invention will become more apparent from the following detailed description when taken in conjunction with the accompanying drawings.

### BRIEF DESCRIPTION OF THE DRAWINGS

FIG. 1 shows an exploded view of a quick-mounting pipe structure according to a first embodiment of the present invention, wherein the pipe structure is provided for connecting to a hydraulic brake lever.

FIG. 2 shows an assembled view of the quick-mounting pipe structure of the first embodiment, wherein the pipe structure is connected to the hydraulic brake lever.

FIG. 3 shows an exploded view of the quick-mounting pipe structure of the first embodiment.

FIG. 4 shows a sectional view of the quick-mounting pipe structure of the first embodiment.

FIG. 5 shows a sectional view of the quick-mounting pipe structure of the first embodiment, wherein the pipe structure is under a locked state.

FIG. 6 shows a sectional view of the quick-mounting pipe structure of the first embodiment, wherein the pipe structure is under an unlocked state.

FIG. 7 shows an exploded view of a quick-mounting pipe structure according to a second embodiment of the present invention, wherein the pipe structure is provided for connecting to a hydraulic brake disc.

FIG. 8 shows an assembled view of the quick-mounting pipe structure of the second embodiment, wherein the pipe structure is connected to the hydraulic brake disc.

FIG. 9 shows an exploded view of a quick-mounting pipe structure according to a third embodiment of the present invention, wherein the pipe structure is provided for connecting to a hydraulic brake disc.

FIG. 10 shows an assembled view of the quick-mounting pipe structure of the third embodiment, wherein the pipe structure is connected to the hydraulic brake disc.

### DETAILED DESCRIPTION OF THE PREFERRED EMBODIMENTS

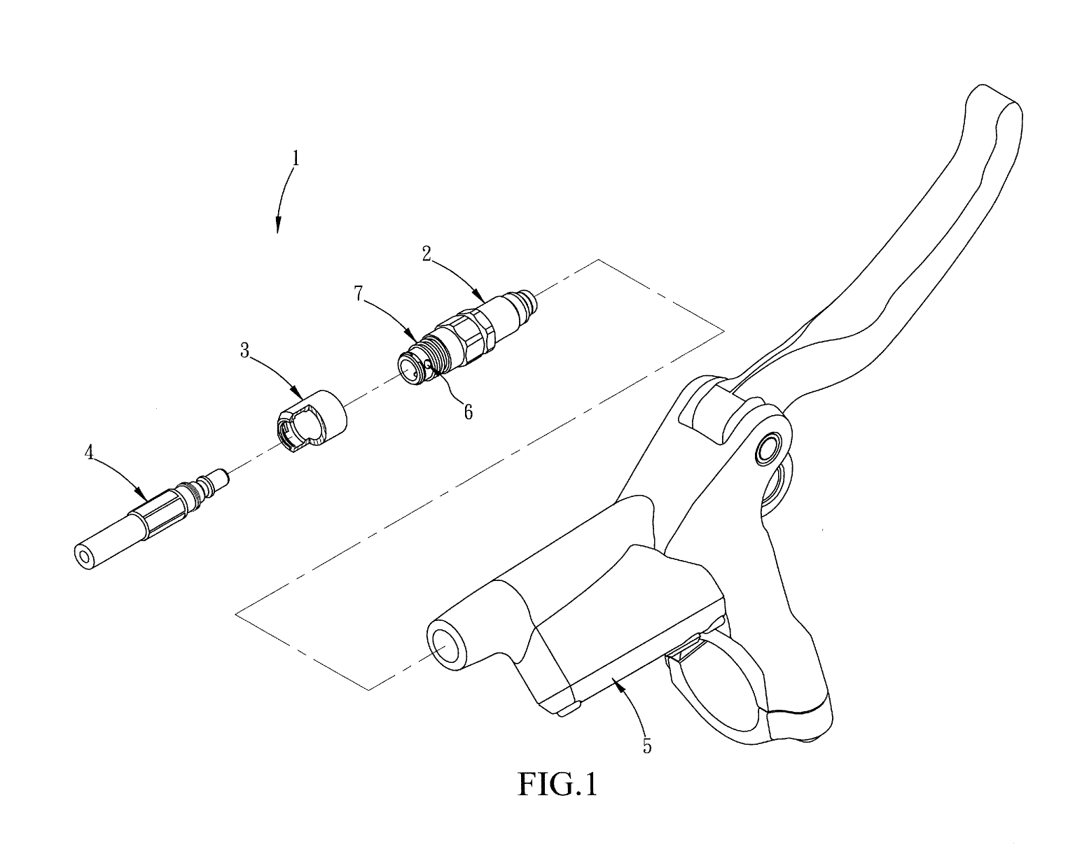

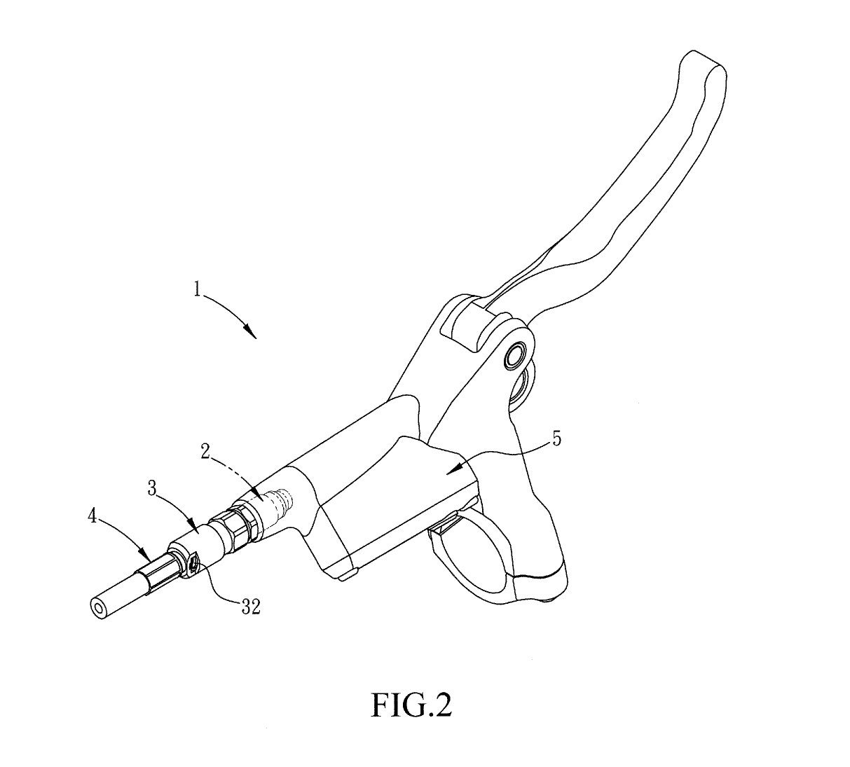

Referring to FIGS. 1 and 2, a quick-mounting pipe structure according to a first embodiment of the present invention is shown, which generally comprises a first tubular fitting 2, a coupling sleeve 3, and a hose assembly 4.

The first tubular fitting 2 has one end that can be fitted into a hydraulic brake lever 5 and an opposite end that is provided with a locking ball 6 that can be moved inwardly to reach a central passage thereof. The first tubular fitting 2 is formed with an outer shoulder at an outer surface of the opposite end and fitted with a coil spring 7. The coil spring 7 can be a compressible coil spring.

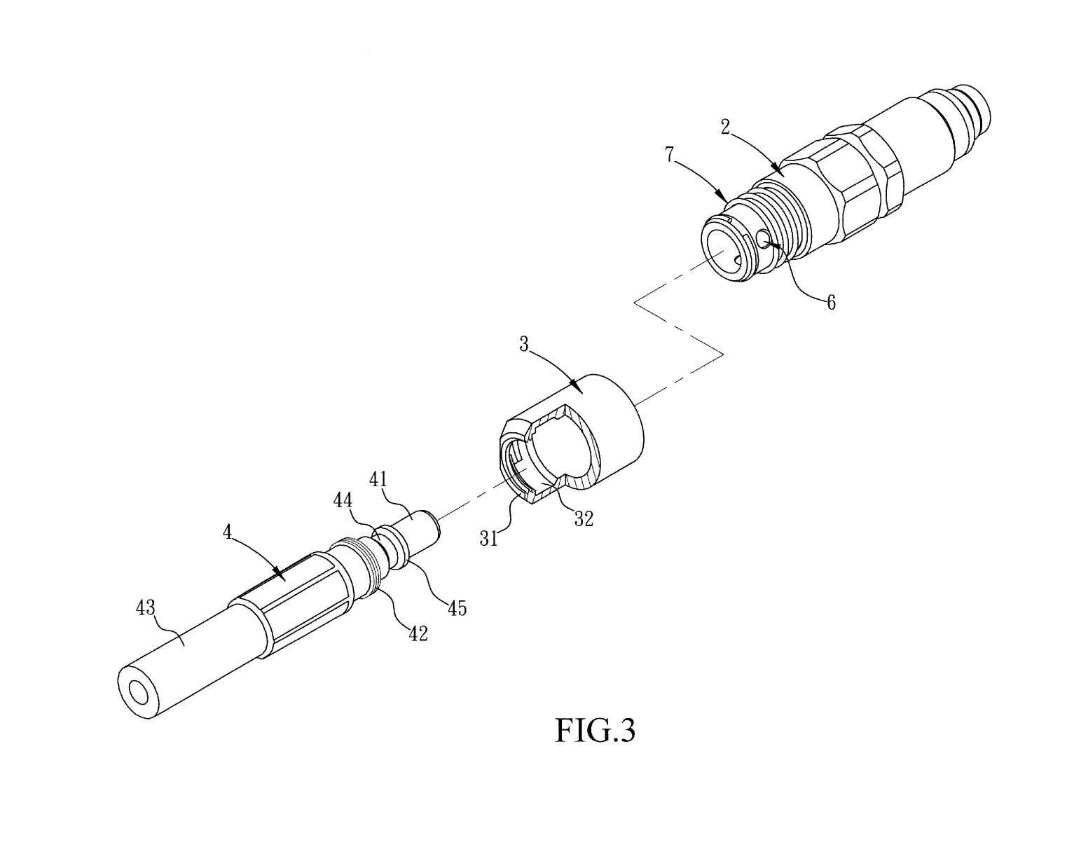

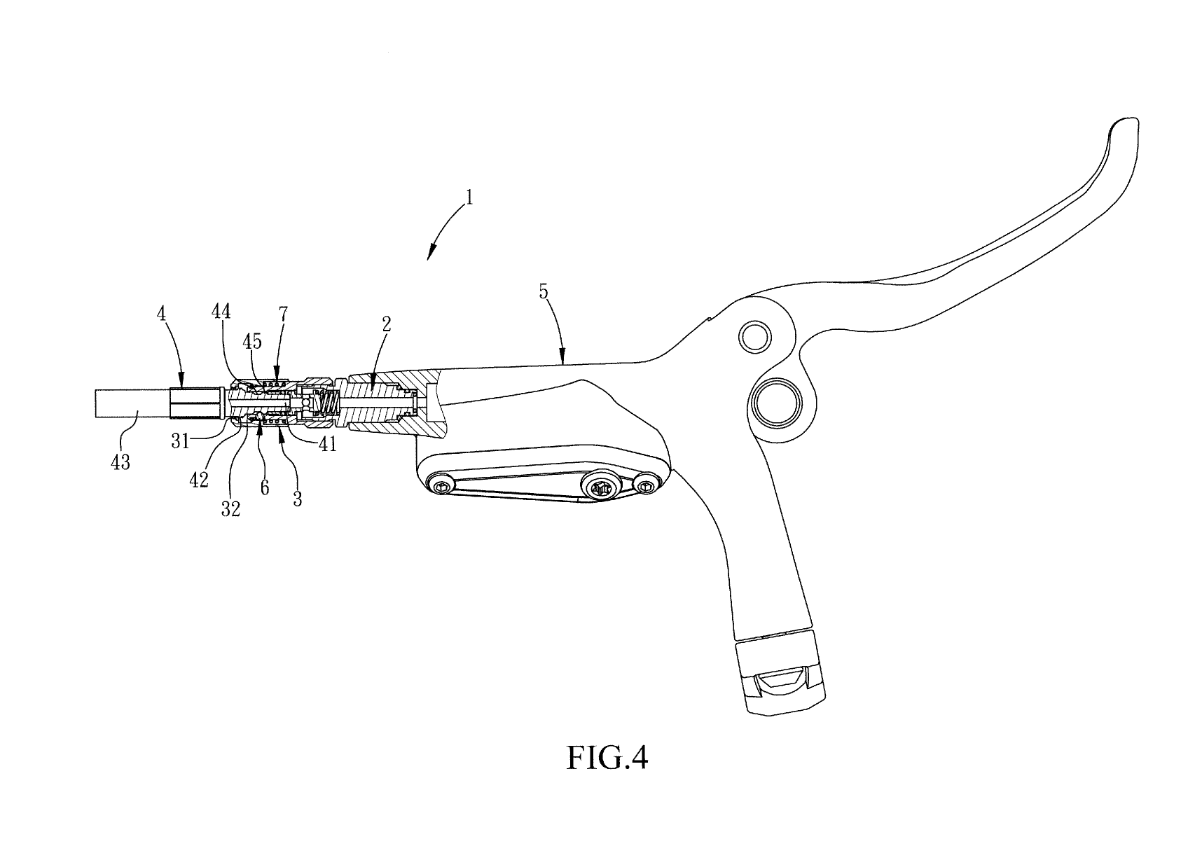

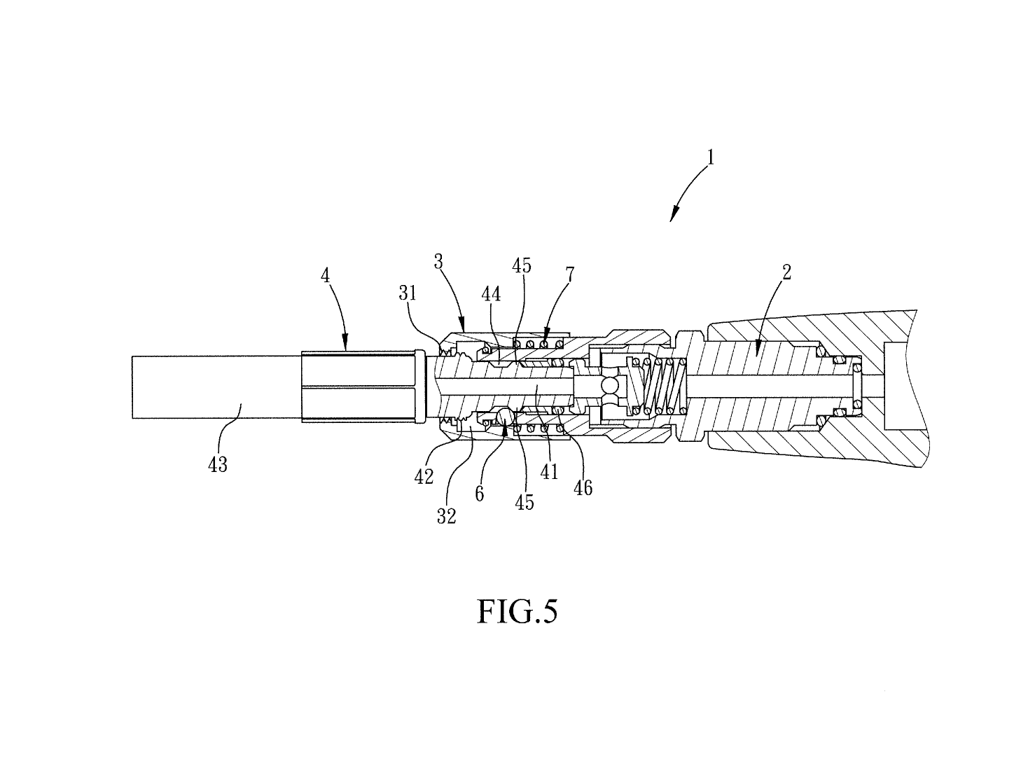

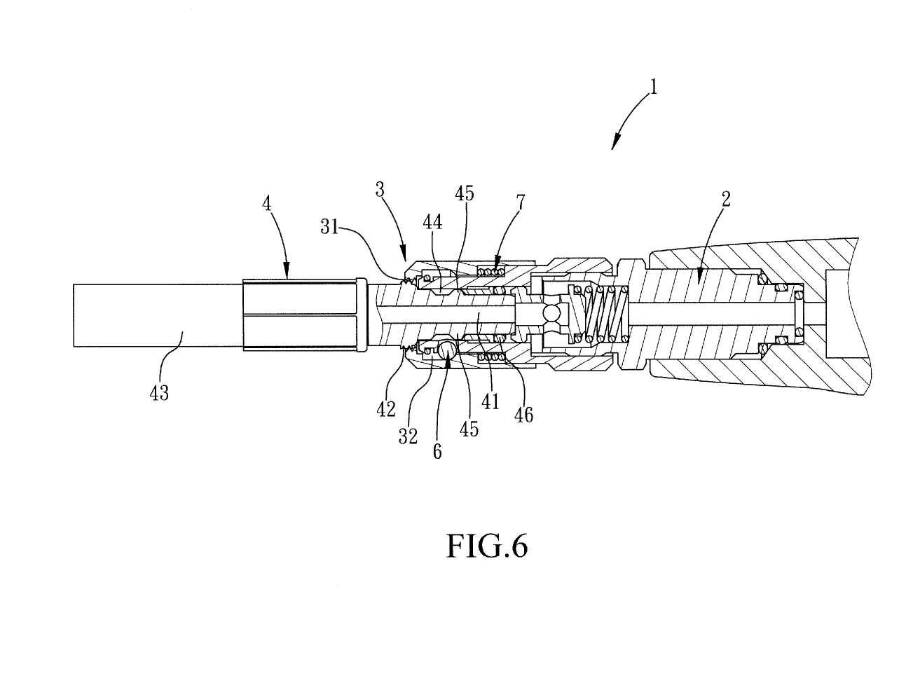

Referring to FIGS. 3 through 6, the coupling sleeve 3 is movably fitted around the first tubular fitting 2 and the coil spring 7. The coupling sleeve 3 is formed with an inner annular protrusion and internal threads 31 at an inner surface thereof. The internal threads 31 are located at one end of the coupling sleeve 3 that is away from the first tubular fitting 2. The inner annular protrusion of the coupling sleeve 3 corresponds to the outer shoulder of the first tubular fitting 2 such that one end of the coil spring 7 is engaged with the outer shoulder of the first tubular fitting 2 and the other end of the coil spring 7 is engaged with the inner annular protrusion of the coupling sleeve. Furthermore, the coupling sleeve 3 can be provided with an observation window 32 between the inner annular protrusion and the internal threads 31 thereof, for allowing a user to see the connecting state of those fittings.

The hose assembly 4, which can direct hydraulic fluid supplied from the hydraulic brake lever 5, includes a hose 43 and a second tubular fitting 41 provided at one end of the hose 43. The second tubular fitting 41 can be inserted into the first tubular fitting 2 and the coupling sleeve 3 for allowing the hose assembly 4 to be connected to the hydraulic device 5. The second tubular fitting 41 is formed with an annular raised portion 45, an annular recessed portion 44 next to the annular raised portion 45, and external threads 42 on its outer surface. The external threads 42 can be threadedly engaged with the internal threads 31 of the coupling sleeve 3. The annular recessed portion 44 can retain the locking ball 6 of the first tubular fitting 2 to allow the second tubular fitting 41 to be locked with the first tubular fitting 2 after the second tubular fitting 41 has been threadedly engaged with the coupling sleeve 3 by the external threads 42 and the internal threads 31, thereby securely connecting the hose assembly 4 to the hydraulic brake lever 5. The annular raised portion 45 can push the locking ball 6 to move outwardly to be clear of the annular recessed portion 44 of the second tubular fitting 41 when disengaging the internal threads 31 from the external threads 42, such that the second tubular fitting 41 can be taken off the first tubular fitting 2 and thus the hose assembly 4 can be removed from the hydraulic brake lever 5.

Furthermore, the second tubular fitting 41 can be fitted with a seal ring 46 around its outer surface in front of the annular raised portion 45 to prevent hydraulic fluid from leakage. The seal ring 46 can be an O-ring or V-ring.

In use, for connecting the hose assembly 4 to the hydraulic brake lever 5, the second tubular fitting 41 of the hose assembly 4 can be inserted into the first tubular fitting 2 to allow the locking ball 6 of the first tubular fitting 2 to move inwardly to be retained in the annular recessed portion 44 of the second tubular fitting 41. At the same time, the coupling sleeve 31 can be rotated relative to the second tubular fitting 41 to allow the internal threads 31 of the coupling sleeve 3 to be threadedly engaged with the external threads 42 of the second tubular fitting 41.

As such, in addition to the locking ball 6 being locked between the first tubular fitting 2 and the second tubular fitting 41, the coupling sleeve 3 is threadedly engaged with the second tubular fitting, thereby providing additional attachment between the first tubular fitting 2 and the second tubular fitting 41 to prevent the second tubular fitting 41 from being pulled out of the first tubular fitting 2 when the pipe structure is subjected to excessive force.

For taking the hose assembly 4 off the first tubular fitting 2 and the coupling sleeve 3, the user may rotate the coupling sleeve 3 relative to the second tubular fitting 41 to have the internal threads 31 disengaged from the external threads 42. During the disengagement, the coupling sleeve 3 can be forced to move towards the first tubular fitting 2 and compress the coil spring 7, and thus the annular raised portion 45 can push the locking ball 6 to move outwardly, so that the locking ball 6 can leave the annular recessed portion 44 of the second tubular fitting 2 to allow the hose assembly 4 to be pulled out of the first tubular fitting 2 and the coupling sleeve 3.

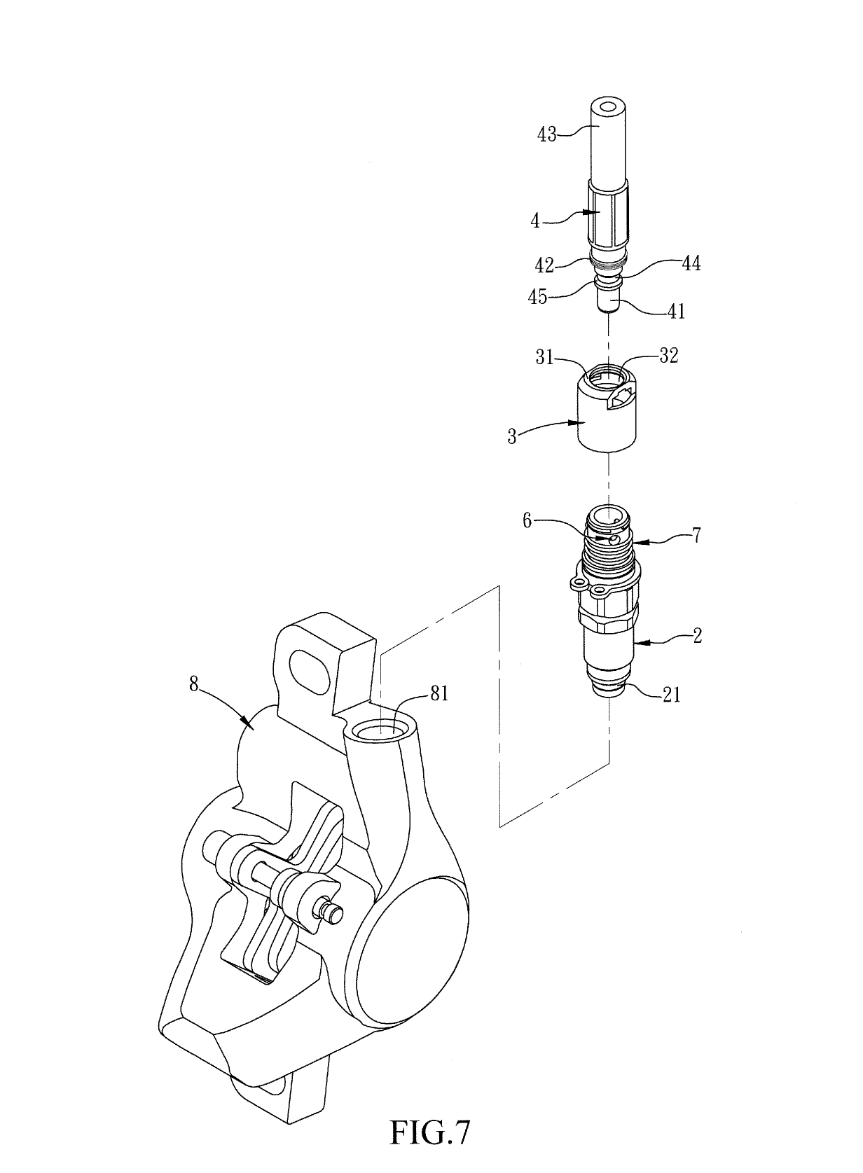

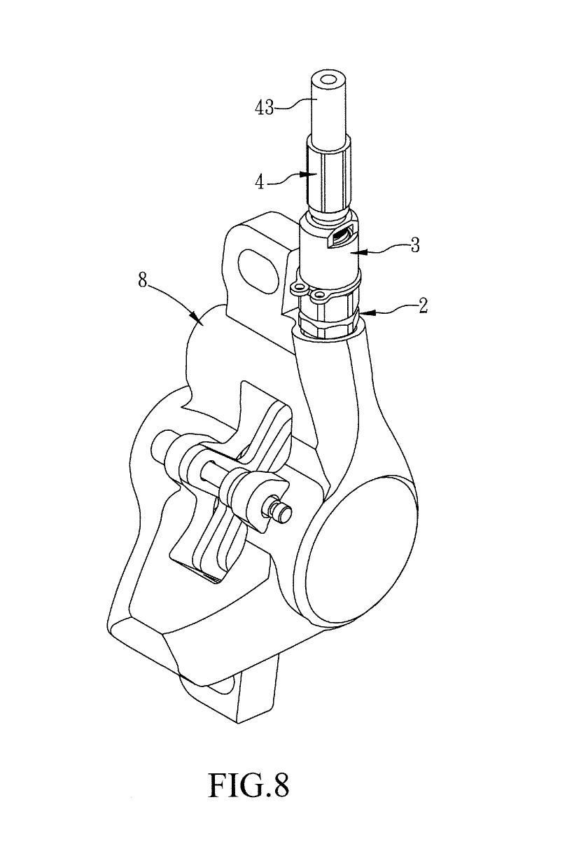

FIGS. 7 and 8 show a second embodiment of the present invention, wherein the first tubular fitting 2 is connected to a hydraulic brake disc 8 instead of the hydraulic brake lever 5 shown in FIG. 1. Furthermore, the first tubular fitting 2 is provided with a threaded portion 21 at the end opposite to the locking ball 6. The threaded portion 21 can be threadedly engaged into a vertical threaded hole 81 of the hydraulic brake disc 8. This embodiment can also provide additional attachment between the first tubular fitting 2 and the second tubular fitting 41 to prevent the hose assembly 4 from being pulled out of the hydraulic brake disc 8 when the pipe structure is subjected to excessive force.

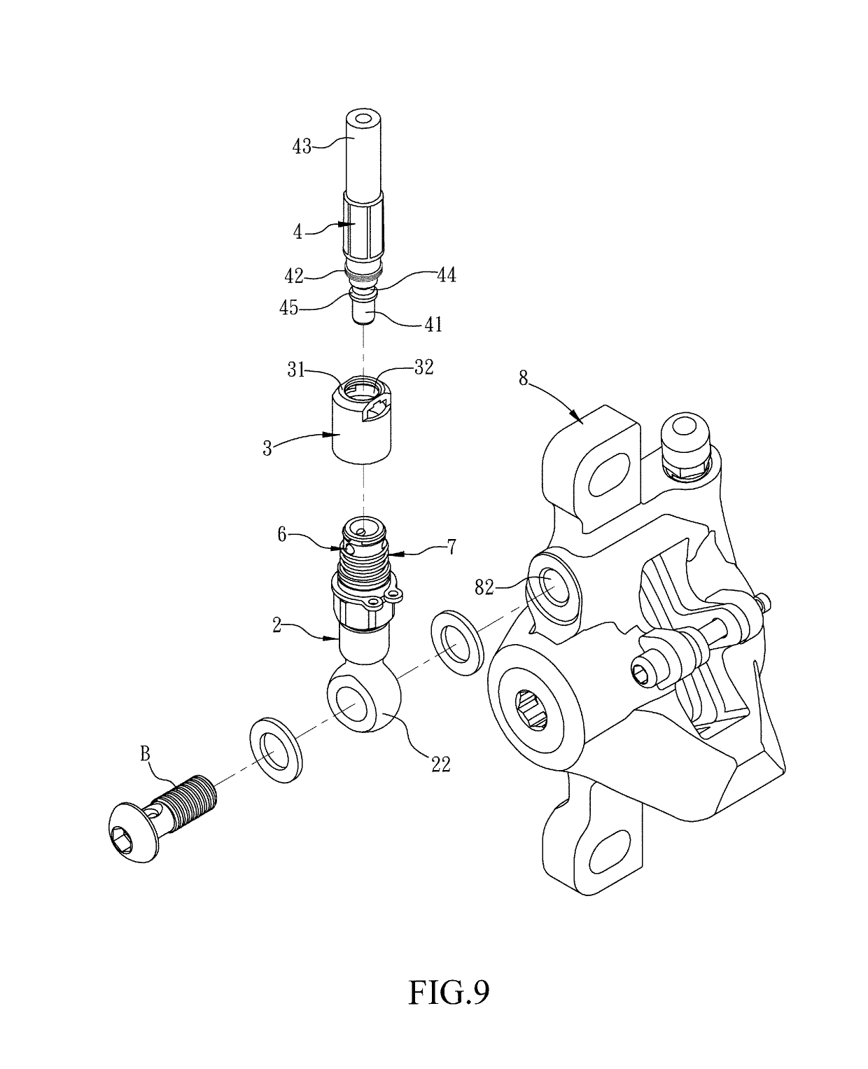

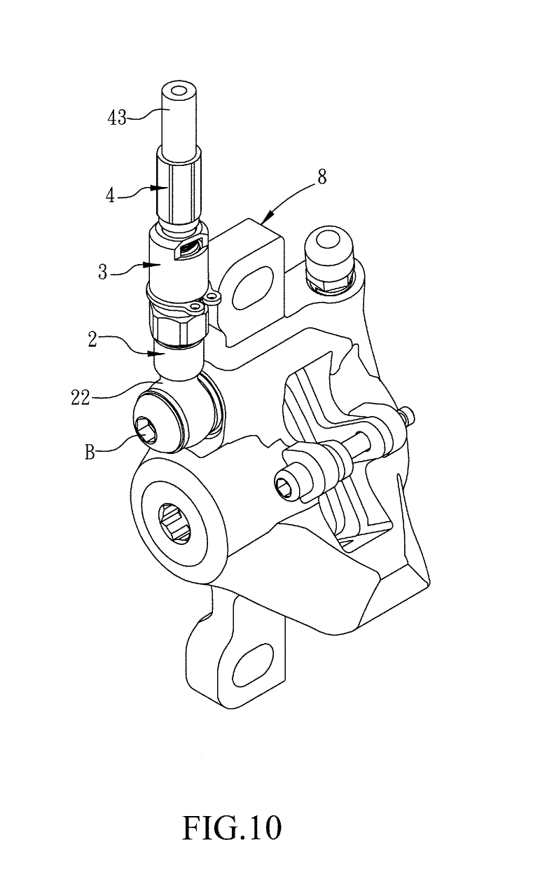

FIGS. 9 and 10 show a third embodiment of the present invention, wherein the first tubular fitting 2 is connected to a hydraulic brake disc 8 of another type. Additionally, the first tubular fitting 2 is provided with a banjo head 22 at the end opposite to the locking ball 6. The first tubular fitting 2 can be connected to the hydraulic brake disc 8 by using a bolt B inserted through the banjo head 22 to be threadedly engaged into a horizontal threaded hole 82 of the hydraulic brake disc 8. This embodiment can also provide additional attachment between the first tubular fitting 2 and the second tubular fitting 41 to prevent the hose assembly 4 from being pulled out of the hydraulic brake disc 8 when the pip structure is subjected to excessive force.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. A quick-mounting pipe structure, comprising:
a first tubular fitting having one end that can be fitted into a hydraulic device and an opposite end that is provided with a locking ball that can be moved inwardly to reach a central passage thereof, the first tubular fitting being formed with an outer shoulder at an outer surface of the opposite end and being fitted with a coil spring;
a coupling sleeve being movably fitted around the first tubular fitting and the coil spring, the coupling sleeve being formed with an inner annular protrusion and internal threads at an inner surface thereof, the internal threads being located at one end of the coupling sleeve that is away from the first tubular fitting, the inner annular protrusion corresponding to the outer shoulder such that one end of the coil spring is engaged with the outer shoulder of the first tubular fitting and the other end of the coil spring is engaged with the inner annular protrusion of the coupling sleeve; and
a hose assembly including a hose and a second tubular fitting provided at one end of the hose, the second tubular fitting capable of being inserted into the first tubular fitting and the coupling sleeve for allowing the hose assembly to be connected to the hydraulic device, the second tubular fitting being formed with an annular raised portion, an annular recessed portion next to the annular raised portion, and external threads on its outer surface, wherein the external threads of the second tubular fitting can be threadedly engaged with the internal threads of the coupling sleeve, the annular recessed portion can retain the locking ball of the first tubular fitting to allow the second tubular fitting to be locked with the first tubular fitting after the second tubular fitting has been threadedly engaged with the coupling sleeve by the external threads and the internal threads, thereby securely connecting the hose assembly to the hydraulic device, the annular raised portion can push the locking ball to move outwardly to be clear of the annular recessed portion of the second tubular fitting when disengaging the internal threads from the external threads, such that the second tubular fitting can be taken off the first tubular fitting and thus the hose assembly can be removed from the hydraulic device.

2. The quick-mounting pipe structure of claim 1, wherein the coupling sleeve is provided with an observation window between the inner annular protrusion and the internal threads thereof.

3. The quick-mounting pipe structure of claim 1, wherein the coil spring is a compressible coil spring.

4. The quick-mounting pipe structure of claim 1, wherein the second tubular fitting is fitted with a seal ring around its outer surface in front of the annular raised portion.

5. The quick-mounting pipe structure of claim 4, wherein the seal ring is an O-ring.

6. The quick-mounting pipe structure of claim 1, wherein the hydraulic device is a hydraulic brake lever or a hydraulic brake disc.
